(19) United States
(12) Patent Application Publication
(10) Pub. No.: US 2010/0065546 A1
(43) Pub. Date: Mar. 18, 2010

(54) Cooking Appliance

(75) Inventor: Ingo Bally, Traunstein (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens hausgerate GmbH, munchen (DE)

(21) Appl. No.: 11/992,217

(22) PCT Filed: Sep. 13, 2006
(86) PCT No.: PCT/EP2006/066328

§ 371 Date: Mar. 18, 2008

(30) Foreign Application Priority Data
Sep. 19, 2005 (DE) 102005044692.2

(51) Int. Cl. F27B 5/14

(52) U.S. Cl. 219/390

(57) ABSTRACT

A cooking appliance, in particular, a cooking appliance which is mounted in an elevated manner, which comprises at least one muffle which defines a cooking chamber and which comprises a muffle opening, a door which is used to close the muffle opening and a drive device which is controlled by a control device and which is used to displace the door. Said drive device comprises at least one drive motor which can be moved by the cables which are connected to the door. The cables, which are lay cables, can be displaced by the drive motor in a linear manner.

The present invention relates to a cooking appliance, in particular a high-level built-in cooking appliance, having at least one muffle that delimits a cooking chamber and has a muffle opening, a door for closing the muffle opening, and a drive device, controlled by means of a control device, for displacing the door, the drive device comprising at least one drive motor by means of which cables connected to the door can be moved. The present invention also relates to an associated operating method.

DE 101 64 239 discloses a high-level built-in cooking appliance in which a drive motor moves a base door by winding up or letting down pull ropes from a rope drum. The ropes are in each case connected to a side of the base door and are deflected by the drive motor relative to the base door via deflection sheaves. The deflection sheaves are equipped with switching elements and associated switches in order to detect a pinching/jamming situation. This can be effected for example by time-delayed switching at the two deflection sheaves.

A generic high-level built-in cooking appliance is also known for example from DE 101 64 237 and DE 102 28 141.

Drives equipped with pitched cables for the purpose of moving sliding sunroofs in automobiles are known from the German company WEBASTO.

A disadvantage with the cooking appliances described is that the use of pull ropes with rope drums for driving and deflecting the ropes takes up a comparatively large amount of space and also that installation and adjustment are relatively complicated.

It is the object of the present invention to provide a cooking appliance having a drive that is more compact and easier to handle.

The present object is achieved by means of the cooking appliance having the features of claim 1 or 10 as well as by a method as claimed in claim 15. Advantageous embodiments may be derived from the dependent claims either individually or in combination.

For this purpose the cooking appliance, which is in particular a high-level built-in cooking appliance, but may also be a cooking appliance having an oven carriage, is equipped with cables which are implemented as pitched cables which can be moved in a linear manner by the drive motor.

Pitched cables frequently have a wire-wrapped steel wire core; other embodiments are also possible.

In one embodiment of the cooking appliance, two pitched cables are provided, each of which is secured on one side to one side of the door. In this case the pitched cables are guided through an extrusion, made e.g. of plastic or aluminum, to a drive wheel of a drive motor by means of which they are linked on opposite sides to a motor shaft. Due to rotation of the drive wheel the pitched cables are displaced linearly in the opposite direction, the door being displaced accordingly in a linear manner.

The use of the pitched cable drive in the cooking appliance results firstly in the advantage of a space-saving design, since the cable drum that would otherwise present at the drive motor is no longer required. Secondly, installation and adjustment are significantly easier compared to the drive comprising a cable drum, since the complicated winding onto the cable drum, for which a cable tensioner is required for example, is unnecessary.

Generally the use of only one or of more than two pitched cables is possible. The synchronous operation of a plurality of motors driving pitched cables is also possible. The fact that the pitched cables are connected to the door means in the general case that they can be secured directly to the door or to an element connected to the door, e.g. a telescopic rod.

It is advantageous for a compact design if at least one pitched cable is deflected between drive motor and door at a support, e.g. if in the case of a high-level built-in cooking appliance the drive motor is mounted centrally on a surface of a housing body and the pitched cables are deflected starting from the motor into vertical, hollow telescopic rods. The supports can be pulleys or non-rotatable supports. Pulleys have the disadvantage that their installation is comparatively complicated. The pitched cables can also slide over a non-rotatable support even without sheathing, in which case care must then be taken to ensure adequate abrasion resistance of the support, which abrasion resistance can be achieved e.g. by hardening, surface coating, extreme hardness of the base material, etc.

It is advantageous for a compact design and easy installation if the drive motor and the supports are mounted on the upper surface of a housing body.

For the purpose of lessening abrasion and for improved operating safety it is advantageous if the pitched cables in each case run at least partially in a guide tube, since they can slide smoothly therein.

It is then particularly advantageous if at least one guide tube for a load-bearing section of a pitched cable (on which a tensile force exerted by the door acts) extends from a guide housing connected to the drive motor as far as up to and including an associated support. As a result the pitched cable is protected in this area from external influences and does not slide directly on the support, which means that the latter does not need to be particularly resistant to abrasion. In this case a rotatable support produces no further advantage over the simpler non-rotatable support.

It is advantageous for easier installation and for low-maintenance operation if the guide tubes are elastically deformable under load.

In this case it is particularly advantageous if at least one support is equipped with a switching device for measuring load. Owing to the elastic deformability of the guide tube the latter is deformed (bent) by the load bearing on a load-bearing section of a pitched cable in such a way that it presses onto the support as a function of load. This enables a load measurement variable to be measured at the support. Two supports are advantageously embodied in such a way for two sides of the door. The measurable load variable is dependent inter alia on a load arm of the guide tube. The guide tube can also have more than one support; depending on the design, a load can then be tapped at more than one support or e.g. only at the last support in the direction of the door or else at the support which most forcefully deflects the pitched cable.

For increased operating safety it is advantageous if each switching device is connected to a control circuit which is configured in such a way that it detects a pinching/jamming situation by evaluating the signals of the switching devices.

The invention can be applied particularly advantageously in a high-level built-in cooking appliance having a base-side muffle opening and a base door.

The invention is also solved by means of a generic cooking appliance in which at least one load-bearing section of a cable between drive motor and door is deflected at a support and runs in a guide tube at least between the drive motor and the support inclusive, and in which the at least one guide tube is elastically deformable under load, and in which at least this support is equipped with a switching device for measuring load. This enables a load measurement to be realized using structurally simple means both for pitched cables and for other cables, e.g. pull cables, and moreover irrespective of the type of drive. Deflection sheaves can therefore be dispensed with.

For the purposes of compact design and easy installation and adjustment it is advantageous if the cables are pitched cables which can be moved in a linear manner by means of the drive motor.

It is then advantageous if at least one guide tube for the load-bearing section of the at least one pitched cable extends from a guide housing connected to the drive motor as far as up to and including the associated support.

The cooking appliance comprising switching device for measuring load can be operated in such a way that the respective switching device for measuring load triggers after a specific load threshold is reached. If only one support is equipped with the switching device, a touching down of the door in the opening direction (relieving of the load on the cable/pitched cable) and in the closing direction (increased loading on the cable/pitched cable) can be inferred. By comparison with the reaching of a target position (e.g. by measuring the position of the door) it is also possible to deduce the occurrence of a pinching/jamming situation if the desired final position on the work surface or the zero position has not yet been reached. For detecting a pinching/jamming situation and the subsequent response, reference can be made to the possibilities described e.g. in DE 101 64 239.

It is advantageous in this case if the supports on both sides are each equipped with a switching device for measuring load, since in this way asymmetrical switching states can be detected and used for recognizing a pinching/jamming situation.

For simple and economical manufacture it is advantageous if the switching device for measuring load has a switching element with associated switch. To detect a pinching/jamming situation in the door's opening direction it is favorable if the switching element triggers the switch after the measured load falls below a specific load threshold. To detect a pinching/jamming situation in the door's closing direction it is favorable if the switching element triggers the switch after the measured load exceeds a specific load threshold.

For more accurate load measurement and improved evaluation it can be advantageous if the switching device for measuring load outputs measured load values in stages or continuously. In this case the switching device can include for example a load measurement outlet and/or resistance strain gauge.

The invention is explained in more detail below with reference to the embodiments shown in the attached schematic figures, in which:

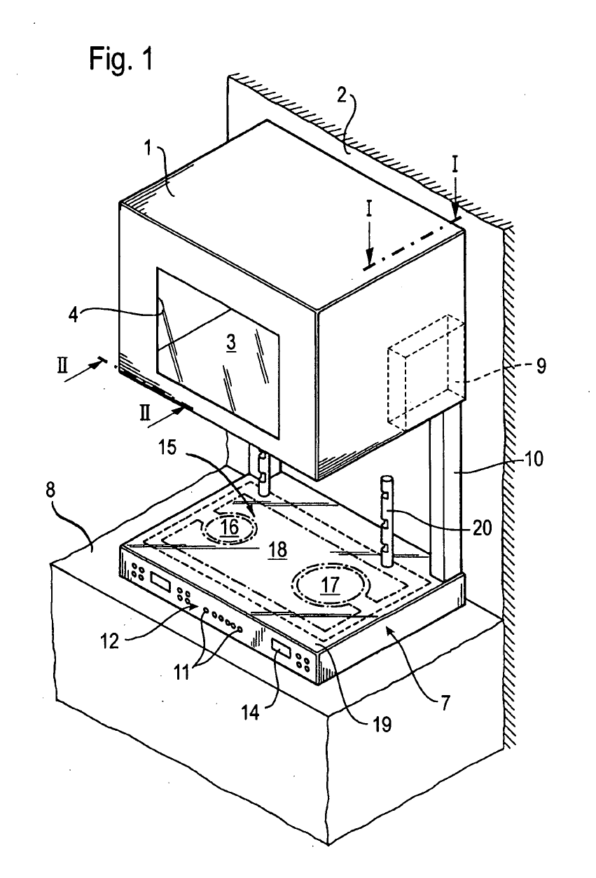

FIG. 1 shows a perspective view of a wall-mounted, high-level built-in cooking appliance with the base door lowered;

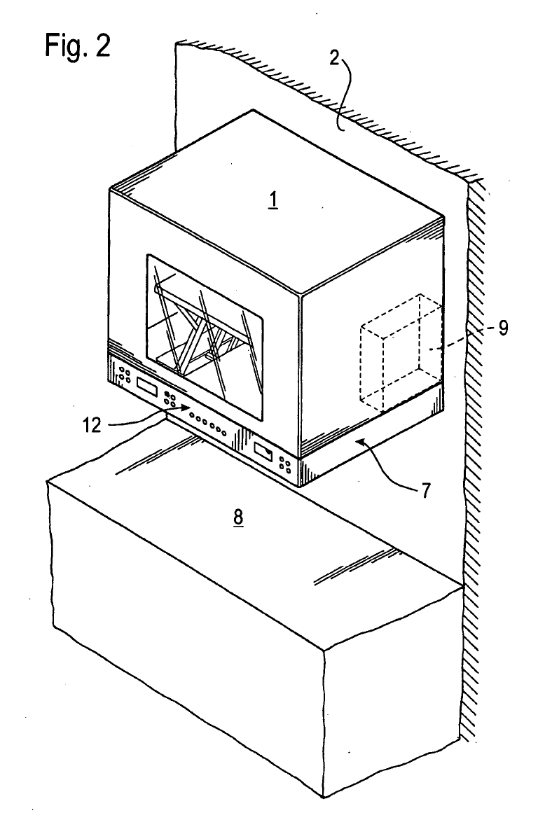

FIG. 2 shows a perspective view of the high-level built-in cooking appliance with the base door closed;

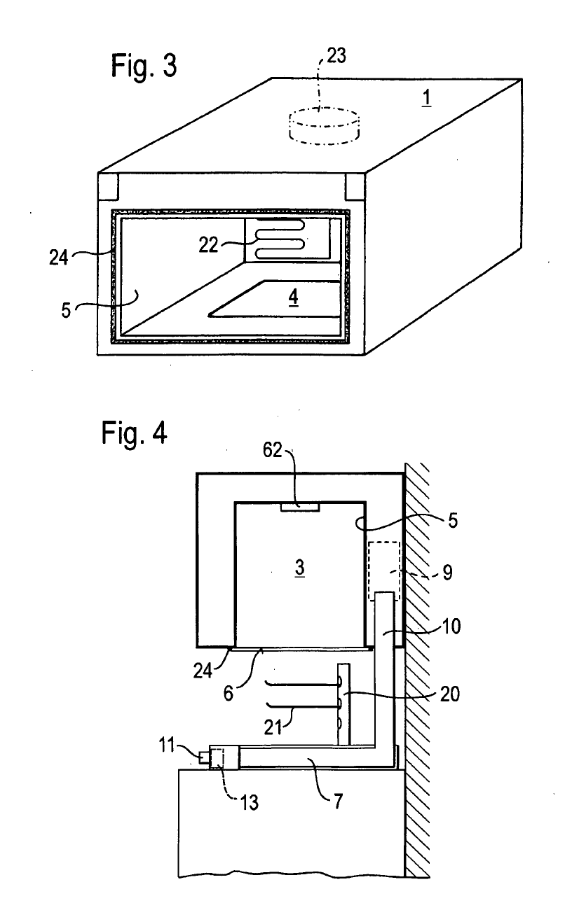

FIG. 3 shows a perspective view of a housing of the high-level built-in cooking appliance without the base door;

FIG. 4 shows a schematic side view, in cross-section along the line I-I shown in FIG. 1, of the wall-mounted, high-level built-in cooking appliance with the base door lowered;

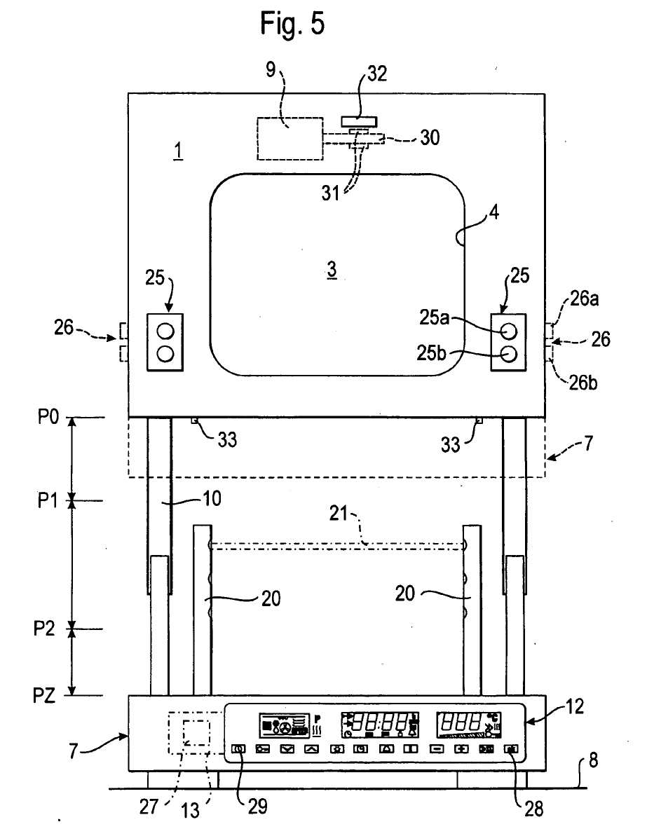

FIG. 5 shows a front view of a further embodiment of a high-level built-in cooking appliance;

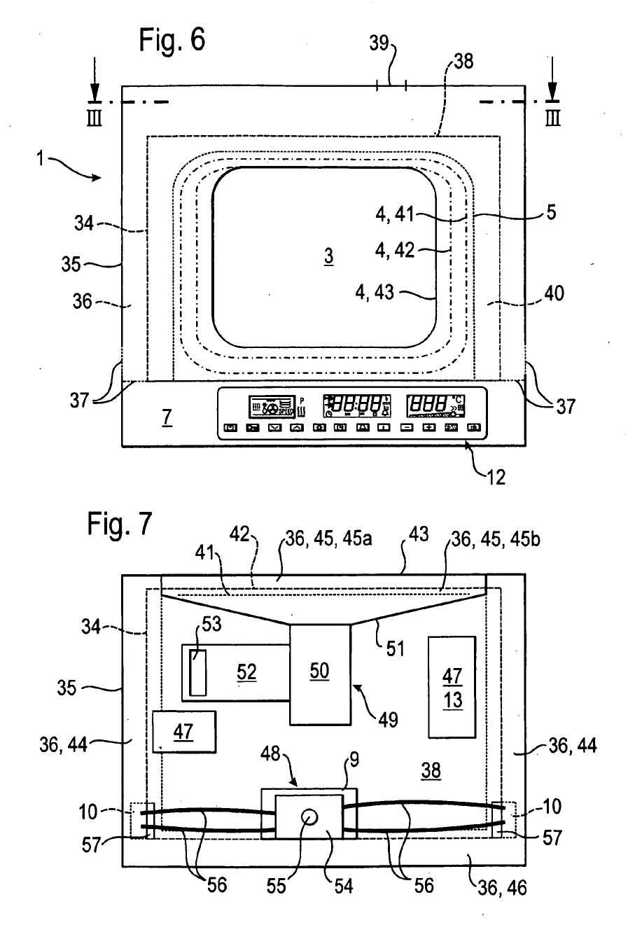

FIG. 6 shows a front view of the embodiment from FIG. 5 in the closed state with a more accurate description of the location of individual housing elements;

FIG. 7 shows a plan view in cross-section of the embodiment from FIG. 6;

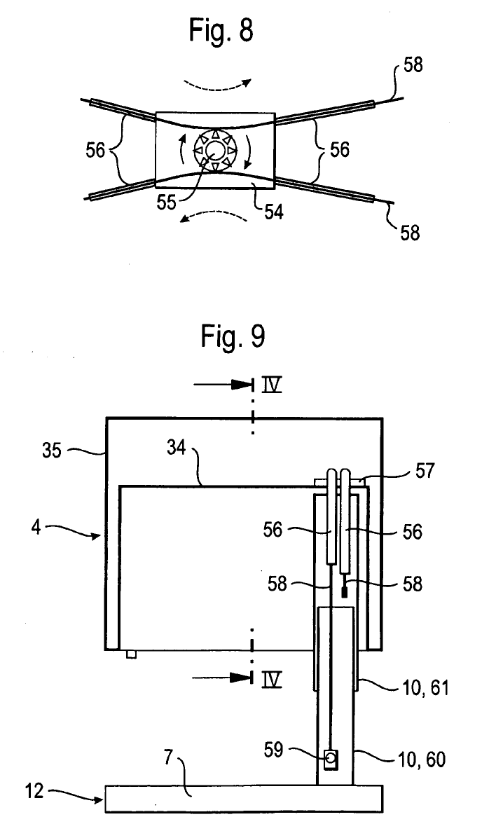

FIG. 8 shows a plan view of parts of the drive device for more precise description;

FIG. 9 shows in a side view analogous to FIG. 4 a view of a further embodiment of the high-level built-in cooking appliance;

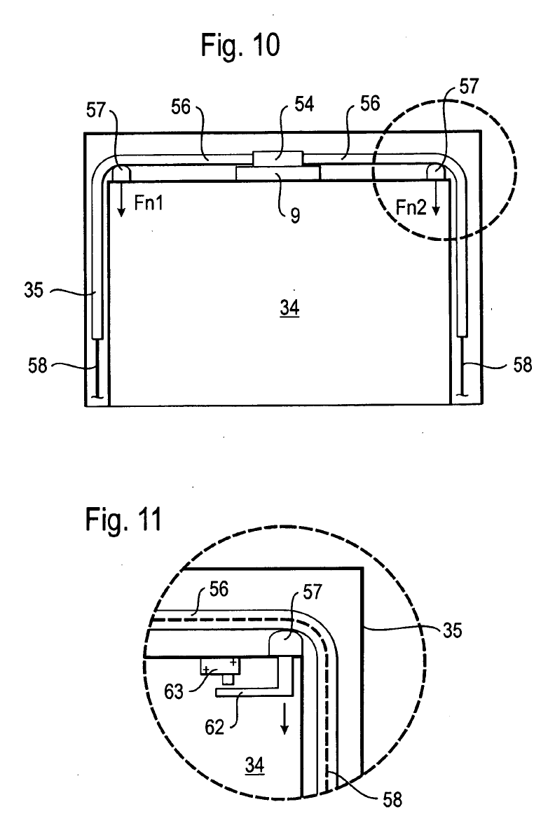

FIG. 10 shows a sectional front view of the embodiment of the cooking appliance according to FIG. 9;

FIG. 11 shows a section from FIG. 10 in greater detail; and

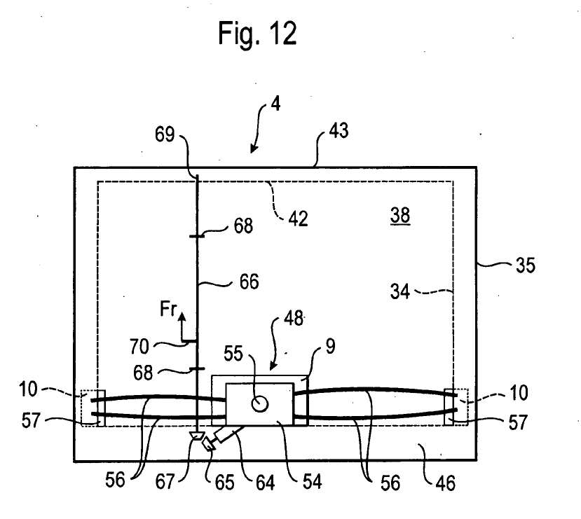

FIG. 12 shows a further embodiment of the high-level built-in cooking appliance with emergency opening arrangement in a representation analogous to FIG. 7.

In the interests of providing a better illustration of the individual elements the figures are not drawn to scale.

FIG. 1 shows a high-level built-in cooking appliance having a housing 1. The rear of the housing 1 is mounted in the manner of a suspended cabinet on a wall 2. Defined in the housing 1 is a cooking chamber 3 that can be monitored through a viewing window 4 incorporated at the front in the housing 1. It can be seen in FIG. 4 that the cooking chamber 3 is delimited by a muffle 5 which is provided with a thermally insulating casing (not shown) and that the muffle 5 has a muffle opening 6 on its base. The muffle opening 6 can be closed by means of a base door 7. The base door 7 is shown in the lowered position in FIG. 1, resting with its underside on a work surface 8 of an item of kitchen furniture. In order to close the cooking chamber 3 the base door 7 must be moved into the position shown in FIG. 2, which is termed the “zero position”. For the purpose of moving the base door 7 the high-level built-in cooking appliance has a drive device 9, 10. The drive device 9, 10 has a drive motor 9, indicated in FIGS. 1, 2 and 4 by means of dashed lines, which is disposed between the muffle 5 and an exterior wall of the housing 1. The drive motor 9 is disposed in the area of the rear of the housing 1 and, as shown in FIG. 1 or 4, is operatively connected to a pair of lifting elements 10 which are linked to the base door 7. According to the schematic side view shown in FIG. 4 each lifting element 10 is therein embodied as an L-shaped support whose vertical limb extends from the drive motor 9 on the housing side. For moving the base door 7 the drive motor 9 can be actuated with the aid of an operating panel 12 and a control circuit 13, which panel is according to FIGS. 1 and 2 arranged at the front on the base door 7. As shown in FIG. 4, the control circuit 13 is located behind the operating panel 12 inside the base door 7. The control circuit 13, consisting here of a plurality of spatially and functionally separate printed circuit boards that communicate via a communication bus, constitutes a central control unit for operating the appliance and controls and/or regulates, for example, heating, displacing of the base door 3, implementing of user inputs, illuminating, pinching/jamming protection, clocking the heating elements 16, 17, 18, 22, and much more.

It can be seen from FIG. 1 that a top side of the base door 7 has a cooking matrix 15. Virtually the entire surface of the cooking matrix 15 is occupied by heating elements 16, 17, 18, indicated in FIG. 1 by dash-dotted lines. According to FIG. 1 the heating elements 16, 17 are two differently sized cooking-hob heating elements spaced apart from each other, while the heating element 18 is a panel heating element provided between and almost enclosing the two cooking-hob heating elements 16, 17. For the user, the cooking-hob heating elements 16, 17 define associated cooking zones or cooking rings; together with the panel heating element 18, the cooking-hob heating elements 16, 17 define a bottom-heat zone. The zones can be indicated by means of a suitable decorative motif on the surface. The heating elements 16, 17, 18 can each be controlled via the control circuit 13.

In the exemplary embodiment shown the heating elements 16, 17, 18 are embodied as radiant heating elements covered by a glass ceramic plate 19. The glass ceramic plate 19 has approximately the same dimensions as the top side of the base door 7. The glass ceramic plate 19 is furthermore fitted with mounting openings (not shown) through which protrude bases for fixing securing parts 20 for supports 21 for items being cooked, as also shown in FIG. 4. Instead of a glass ceramic plate 19 it is also possible to employ other—preferably fast-reacting—coverings, for example a thin metal plate.

With the aid of an operating knob provided in the operating panel 12 the high-level built-in cooking appliance can be switched to a cooking-hob operating mode or bottom-heat operating mode, which are explained below.

In the cooking-hob operating mode the cooking-hob heating elements 16, 17 can be controlled individually via the control circuit 13 by means of control elements 11 provided in the operating panel 12, while the panel heating element 18 remains in the non-operating state. The cooking-hob operating mode can be used with the base door 7 lowered, as is shown in FIG. 1. However, it can also be used within the scope of an energy-saving function when the cooking chamber 3 is closed with the base door 7 raised.

In the bottom-heat operating mode not only the cooking-hob heating elements 16, 17 but also the panel heating element 18 are controlled by the control device 13.

In order to achieve maximally even browning of items being cooked during the bottom-heat mode it is critical that the cooking matrix 15 providing the bottom heat should distribute the heating output evenly across the surface of the cooking matrix 15, even though the heating elements 16, 17, 18 have different nominal outputs. The heating elements 16, 17, 18 are therefore preferably not switched to continuous operation by the control circuit 13; instead, the power supply to the heating elements 16, 17, 18 is clocked. The different nominal heat outputs of the heating elements 16, 17, 18 are therein reduced individually in such a way that the heating elements 16, 17, 18 will distribute the heating output evenly across the surface of the cooking matrix 15.

FIG. 3 schematically illustrates the position of an air circulation pot 23 having an air circulation motor and an associated ring heating element, e.g. for generating hot circulating air in the case of a hot-air mode of operation. The air circulation pot 23, which is open toward the cooking chamber, is typically separated from the latter by a deflector (not shown). Further provided attached to a top side of the muffle 5 is a top-heat heating element 22 that can be embodied as of single-circuit or multiple-circuit design, for example having an inner and an outer circuit. The various operating modes such as, for example, also top-heat, hot-air or quick-heat mode can be set by means of the control circuit 13 by appropriately switching or setting the heat output of the heating elements 16, 17, 18, 22, possibly with activating of the fan 23. The heat output can be set by means of suitable clocking. The cooking matrix 15 can furthermore be embodied otherwise, for example with or without a roasting zone, as a pure—single-circuit or multiple-circuit—warming zone without cooking rings, and so forth. The housing 1 has a seal 24 facing toward the base door 7.

The operating panel 12 is normally arranged on the front of the base door 7. Other arrangements are alternatively also conceivable, for example on the front of the housing 1, distributed over different partial panels, and/or in part on side surfaces of the cooking appliance. Further embodiments are possible. The control elements 11 are not limited in their structural design and can include, for example, operating knobs, toggle switches, pushbuttons, and plastic membrane keys that include display elements 14, for example LED, LCD and/or touchscreen displays.

FIG. 5 is a schematic front view (not to scale) of a high-level built-in cooking appliance in which the base door 7 is open and resting on the work surface 8. The closed state is indicated by dashed lines.

In this embodiment there are two displacement switch panels 25 on the front of the permanently attached housing 1. Each displacement switch panel 25 includes two pushbuttons, namely a top CLOSE pushbutton 25a for a base door 7 moving upward in the closing direction and a bottom OPEN pushbutton 25b for a base door 7 moving downward in the opening direction. Without automatic operation (see below) the base door 7 will move upward, if possible, only through continuously simultaneously pressing the CLOSE buttons 25a on both displacement switch panels 25; the base door 7 will also move downward, if possible, only through continuously simultaneously pressing the OPEN buttons 25b on both displacement switch panels 25 (manual operation). Since the user will be more attentive to operation during manual operation and, moreover, both hands are used in that case, pinching or jamming protection will then only be optional. In an alternative embodiment displacement switch panels 26 are attached to opposite outer sides of the housing 1 along with corresponding CLOSE buttons 26a and OPEN buttons 26b, as indicated by dotted lines.

The control circuit 13, which is indicated by dash-dotted lines and located inside the base door 7 behind the operating panel 12, switches the drive motor 9 in such a way that the base door 7 will start moving gently, i.e. not abruptly through simple turning on of the drive motor 9 but by means of a defined ramp.

In this exemplary embodiment the control circuit 13 includes a memory unit 27 for storing at least one target or displacement position P0, P1, P2, PZ of the base door 7, preferably equipped with volatile memory chips, for example DRAMs. After one of the buttons 25a, 25b or 26a, 26b on the displacement switch panels 25 or 26, respectively, has been actuated, if a target position P0, P1, P2, PZ has been stored the base door can continue moving automatically in the direction set until the next target position has been reached or one of the buttons 25a, 25b or 26a, 26b has been actuated again (automatic operation). In this exemplary embodiment the bottommost target position PZ corresponds to the maximum opening, the (zero) position P0 corresponds to the closed state, and P1 and P2 are freely selectable intermediate positions. When the last target position for a direction has been reached, it will thereafter be necessary to proceed using manual operation if that is possible (meaning if the last end positions do not correspond to a maximum open state or to the closed final state). Analogously, if no target position has been stored for a direction—which would be the case, for example, for an upward movement to the closed position if only PZ has been stored but not P0, P1, P2—, a displacement in said direction will have to take place using manual operation. Automatic operation will not be possible if no target position has been stored, for example in the case of a new installation or following a disconnection from the a.c. power supply. Pinching/jamming protection will preferably have been activated if the base door 7 is displaced in the automatic operating mode.

Automatic operation and manual operation are not mutually exclusive: Continuously actuating the displacement switch panel(s) 25, 26 causes the base door 7 to move also during manual operation if it were possible to move to a target position in said direction. It is therein possible to, for example, specify a maximum actuating time, for instance 0.4 seconds, for the displacement panels 25 and 26, or for the associated buttons 25a, 25b and 26a, 26b respectively, for activating automatic operation.

A target position P0, P1, P2, PZ can be any position of the base door 7 between and including the zero position P0 and the maximum open position PZ. However, the maximum stored open position PZ does not have to be the position resting on the work surface 8. The target position P0, P1, P2; PZ can be stored with the base door 7 at the desired target position P0, P1, P2, PZ by, for example, actuating a confirmation button 28 in the operating panel 12 for several seconds (for example two seconds continuously). For the sake of greater clarity existing optical and/or acoustic signaling devices that feed out relevant signals when a target position has been stored have not been drawn. The desired target position P0, P1, P2, PZ requiring to be set is moved to by, for example,—in this exemplary embodiment operating the displacement switch panels 25 or 26 with both hands and performing a manual displacement up to said position. The desired target position P0, P1, P2, PZ requiring to be set is arrived at by, for example,—in this exemplary embodiment operating the displacement switch panels 25 or 26 with both hands and performing a manual displacement up to said position.

Just one target position or, as shown in this exemplary embodiment, also a plurality of target positions P0, P1, P2, PZ can be stored in the memory unit 27. In the case of a plurality of target positions P0, P1, P2, PZ, these can be moved to consecutively by actuating the corresponding displacement buttons 25a, 25b or 26a, 26b. A plurality of target positions P0, P1, P2, PZ will allow the high-level built-in cooking appliance to be adjusted conveniently to the different operating heights desired by a plurality of users. The target position(s) can advantageously be deleted and/or overwritten. In one embodiment, for example, just one target position can be stored in the open state, while the zero position P0 will be detected automatically and can be moved to automatically. Alternatively, the zero position P0 must also be stored so that it can be moved to automatically.

For an ergonomic use it is particularly advantageous for the or a target position P1, P2, PZ to open the base door 7 at least approximately 400 mm to approximately 540 mm (meaning P1-P0, P2-P0, PZ-P0≧40 cm to 54 cm). At this extent of opening the supports 21 for items being cooked can be easily inserted into the securing parts 20. It is favorable in this case for the viewing window 4 to be mounted approximately at the user's eye level or somewhat lower, for example by means of a template indicating the dimensions of the cooking appliance.

A power failure buffer for bridging power outages lasting approximately 1 to 3 s, preferably up to 1.5 s, is present though not illustrated in the drawing.

The drive motor 9 shown in FIG. 1 has at least one sensor unit 31, 32 arranged on a motor shaft 30, where applicable in front of or behind a gear, for the purpose of measuring a displacement path or, as the case may be, a position and/or speed of the base door 7. The sensor unit can include, for example, one or more induction sensors, Hall-effect sensors, optoelectronic sensors, SAW sensors, and so forth. For simple path and speed measurement, two Hall-effect (sub-)elements 31 are here attached to the motor shaft 30 such that they are offset by 180° —i.e. opposite each other—and a Hall-effect sensing element 32 is statically attached at a distance at this area of the motor shaft. When a Hall-effect element 31 then passes the sensing element 32 as the motor shaft 30 rotates, a measuring or sensor signal will be produced that in a good approximation is digital. With (not necessarily) two Hall-effect elements 31, therefore, two signals will be output during one rotation of the motor shaft 30. The speed vL of the base door 7 can be determined by evaluating the time of said signals, for example their time difference, for instance by way of comparison tables or through real-time conversion in the control circuit 13. A displacement path or, as the case may be, a position of the base door 7 can be determined by adding or, as the case may be, subtracting the measurement signals.

A speed-regulating means can implement the speed via, for example, a PWM-controlled power semiconductor device.

For determining the zero point, travel measuring is automatically reset by initializing in the zero position P0 of the base door 7 each time it is moved so that for example a faulty sensor signal output or, as the case may be, pick-up will not propagate.

The drive motor 9 can also be operated by actuating both displacement switch panels 25 or 26 even with the main switch 29 deactivated.

Instead of two separate switches per displacement panel 25, 26, a single switch per displacement panel is also possible, for example a toggle switch that has a neutral position and switches only under pressure. Other forms are also possible. The nature and arrangement of the control elements 28, 29 of the operating panel 12 are not limited, either.

The arrangement of the control circuit 13 and the way it is distributed is therein flexible and not limited, so it can also include a plurality of boards, for example a display board, a control board and a lift board which are spatially separated.

A 4-mm opening extent can be detected by means of end switches 33 which on actuation deactivate a pinching/jamming protection.

The high-level built-in cooking appliance can also be embodied without a memory unit 27, in which case automatic operation is then not possible. This can be expedient for increased operating safety, for example as a safeguard against pinching/jamming.

FIG. 6 shows a schematic front view (not to scale) indicating the position of individual elements of the housing 1 in the closed state, wherein the base door 7 comes to rest on the muffle 5 in a closing manner and at the same also optically closes off the housing 1. The housing 1 consists of an (inner) housing body 34 (indicated by a dashed line) and a housing cover or panel 35 which surrounds the housing body 34 at least in front and at the sides. The intermediate space 36 between housing body 34 and housing cover 35 is embodied such that cooling air can at least partially flow through. For that purpose, bottom ventilation openings 37, e.g. ventilation slots, are provided in the housing cover 35, said ventilation openings being positioned lower than the upper surface 38 of the housing body 34, preferably in an area close to the muffle opening or the lift base 7. The ventilation openings 37 are in this case incorporated on the underside of the housing cover 35, but can also be present for example at the sides. Similarly, one or more top ventilation openings 39, e.g. an air vent slot, are located in the top part of the housing cover 35, especially in the cover thereof. By this means an air stream of cooling air can be built up through the intermediate space 36, typically from bottom to top, which is then discharged through the cover.

The muffle 5 (indicated by a dotted line) is incorporated in the housing body 34, the associated intermediate space 40—excluding the front side—being lined with insulating material. The muffle 5 is embodied in an inverted U shape. In order to be able to see into the cooking chamber 3, a plurality of viewing windows 4 are present, specifically a first (inner) viewing window 41 (indicated by a dash-dotted line) directly covering the muffle 5, which therefore at least partially constitutes a wall of the muffle 5, also a second (middle) viewing window 42 (likewise indicated by a dash-dotted line) retained by means of the housing body 34, and a third (outer) viewing window 43 in the housing cover 35.

Further intermediate windows (not shown) may optionally be incorporated, preferably fixed to the housing body 34, or fewer viewing windows 4 may be present, e.g. only the inner and the outer viewing window 41, 43. The ventilation slots 37, 39, for example, can also be incorporated in an alternative arrangement and shape.

FIG. 7 shows in a top view onto the housing 1 corresponding to the intersecting plane from FIG. 6 (i.e. without top housing wall) a more detailed view (not to scale) of the housing interior with different elements disposed therein. From this viewpoint the intermediate spaces 36 between housing body 34 and housing cover 35 are clearly recognizable, specifically the intermediate spaces 44 at the sides, the front intermediate space 45, and the rear intermediate space 46. Because of the three viewing windows 41, 42, 43 the front intermediate space 45 is subdivided vertically into a first front intermediate space 45a between middle viewing window 42 and outer viewing window 43 and a second front intermediate space 45b between middle viewing window 42 and inner viewing window 41. Of course the intermediate spaces do not have to be empty, but can have different elements disposed therein, such as e.g. lifting elements 10, retaining fixtures, passages, insulation, air guiding elements such as air deflecting plates, screws, struts, etc., while it is also not necessary for every intermediate space 36 to permit a significant air stream.

Mounted on the housing body 34 are in particular: electrical and/or electronic modules 47 such as the control circuit 13, a drive device 48 and a ventilation device 49.

The ventilation device 49 comprises at least one fan, which in this embodiment is precisely one fan, which draws in air from two directions by means of two intake openings. For this purpose use is advantageously made of a two-part fan in which in addition the exhaust air is discharged at least essentially unmixed. Particularly suitable is the dual radial-flow fan 50, shown here, which has two opposing intake openings and discharges drawn-in air at the sides, the two drawn-in air flows being discharged essentially parallel to each other at the sides.

In the structural form shown here, one intake opening of the dual radial-flow fan 50 is connected to an intake duct 51 which at least partially covers the front intermediate space 45 from above and by this means draws in cooling air from below from the bottom ventilation openings 37 through the front intermediate space 45 during operation. As a result the front intermediate space 45, which provides relatively low heat insulation due to the viewing windows 4, 41-43, is cooled for improved user safety.

The other (rear) intake opening of the dual radial-flow fan 50 is open. This causes cooling air to be drawn in particularly from the intermediate spaces 44 at the sides and the rear intermediate space 46 and to flow across the upper surface 38 to the fan 50. As a result the components arranged on the upper surface 38 also have air circulating around or through them and are thereby cooled. This is advantageous in particular for the electronic modules 47.

The exhaust air of the fan 50 runs through an exhaust air duct 52 to an upper air outlet 53 which expels the air through the ventilation opening(s) 39 from FIG. 6.

The drive device 48 comprises a motor 9 which is fixed centrally on the surface 38 of the housing body 34 and on which a guide housing 54 is supported. Two guide channels (not shown) run through the guide housing 54. The guide housing 54 has a circular cutout for introducing a pinion 55 of the motor 9. The guide channels lead in a laterally open manner past the cutout so that cords, cables, etc. in the guide channels are brought into engagement with the pinion 55. Fitted to the outer openings of the guide channels, i.e. in this case to four openings, are guide tubes 56 which together with the guide channels form end-to-end cable ducts. In this embodiment the guide tubes 56 extend from the guide housing 54 as far as the edge of the upper surface 38 into an area above the lifting elements 10 and onward beyond the edge downward into the lifting elements 10.

A pitched cable runs in each of the two cable ducts as a drive cable (not shown). The pitched cable has a flexible metal core and is wrapped in wire. One end of each pitched cable is permanently connected to the base door 7, while the other is free. Since both pitched cables are in engagement with the pinion 55 at opposite sides, they are displaced in a linear manner in opposite directions due to the rotation of the pinion 55. The pitched cable drive can be obtained from the company WEBASTO, Germany, for example.

The guide tubes 56 are elastically deformable, e.g. shaped from die-cast aluminum. At least one load-bearing guide tube 56 (i.e. a guide tube 56 which guides a section of a pitched cable which is permanently connected—directly or indirectly—to the base door 7; as a result a load is present at this section of the pitched cable) rests on a support 57, the bearing force being dependent on the size of the load on the pitched cable. In this embodiment a support 57 of this kind is provided for each load-bearing guide tube 56. The supports 57 are essentially located at the edge of the upper surface 38 of the housing body 34, such that the length deflectable under load—the “arm”—of the guide tube 56 becomes great. As a result the load dependence of the essentially vertical force exerted by the respective guide tube 56 on the support 57 is embodied as large as possible. The bearing force is dependent for example on the loading of the base door 7 or on a touching down on a base or an object. By measuring the bearing force it is possible for example to detect an overloading of the base door 7 or to implement an anti-pinch/jamming protection means.

The length of the guide tubes 56 is a matter of structural discretion and can be comparatively short or extend as far as the securing fixture of the pitched cable on the base door 7 (in the closed state).

In order to use the support of the pitched cables for load measurement, the use of guide tubes 56, though advantageous for reasons of sliding and abrasion, is not absolutely essential. It is also possible to guide the pitched cables—or cables or cords generally—freely via suitably positioned (e.g. extending over the edge of the surface) supports. The supports are then favorably implemented accordingly, e.g. from a suitably hard material and/or material with good sliding properties, surface-treated or surface-coated.

The use of a pitched cable is also not obligatory, but is advantageous on account of the simple construction and installation as well as the displacement precision. Alternative drives include for example types with a cable drum drive, etc.

For a more accurate description of the drive principle, FIG. 8 shows in a plan view the guide housing 54 with the guide tubes 56 connecting thereto and forming two separate guide channels, i.e.—in this representation—an upper and a lower guide channel. A pitched cable 58, typically in the range of one meter in length, runs in each of the guide channels 54, 56. The guide channels lead the pitched cables 58 to a cutout in the guide housing 54 through which a toothed wheel or pinion 55 driven by the drive motor is inserted. The teeth of the pinion 55 are in engagement with the wire wrapping of the respective pitched cable 58 which from the viewpoint of the pinion 55 forms a kind of linear sequence of teeth.

As a result of the rotation of the pinion 55 by means of the drive motor in this case in the clockwise direction as represented by the unbroken arrows the upper pitched cable 58 is displaced linearly from left to right and the lower cable 58 is displaced to the same extent from right to left, as indicated by the dashed arrows.

Because the pitched cables 58 are continuously engaged with the pinion 55 and hence are permanently coupled to the drive motor, effective locking of the base door can also be achieved in the opening direction, e.g. to protect against opening of a hot cooking chamber, during pyrolysis for example, or when the child safety lock is activated. To lock the door in prior art appliances, a mechanical locking means is used which locks the door typically by means of a locking hook as a function of certain parameters such as a threshold temperature, etc. A locking mechanism of this kind can be dispensed with, however, if the drive motor, for example according to reference sign 9 from FIG. 7, drives the pinion 55 via a self-locking gear (not shown). If the drive motor is switched off—which preferably takes place by disconnection of the power and deactivation of direction switches—a mechanical force and an induction force of the drive motor must be overcome in order to open the cooking chamber, or generally for moving the base door. The force applied therefor must be all the greater, the greater the transmission ratio of the gear. For the embodiment shown, a transmission ratio in the range from 30:1 to 60:1 has proved to be a good compromise between self-locking and displacement speed. In particular a transmission ratio in the range from 40:1 to 50:1, especially 45:1, is suitable. At a transmission ratio of 45 the base door could not be opened with a loading of more than 20 kg.

One of a number of possible embodiments of the gear is a worm gear. Other types of gear are known to the person skilled in the art from mechanical engineering.

Of course, the transmission ratio is not limited to this range, but can be adjusted by the person skilled in the art for example to match the specifications of the drive motor used, the mechanical friction of the actuating mechanism of the base door, the type of drive (pitch cable, cable drum, etc.), the weight and loading of the base door, and much more.

FIG. 9 shows in a side view analogous to FIG. 4 a view of a further embodiment of the high-level built-in cooking appliance with a more precise description of the drive device from FIGS. 7 and 8. In the interest of better illustration, the drive motor 9, the guide housing 54, the ventilation device 49 and the electronic modules 47 are not drawn in the figure. The other side of the cooking appliance is constructed analogously.

Clearly to be seen are the elastically deformable guide tubes 56 which rest on the support 57 at the top and then lead, bent downward, into the lifting elements 10. The pitched cables 58 emerge from the free openings of the guide tubes 56, i.e. an, on this side, load-bearing section of a pitched cable 58 (left) which is permanently connected via a fixing element 59 to the lower telescopic rod 60 of the lifting element 10, and thus indirectly to the base door 7. The other (right-hand) pitched cable 58 has a free end on this side. On the other side of the cooking appliance the other pitched cable 58 in each case is fixed or, as the case may be, free. Actuating the drive motor causes the pitched cables 58 to be displaced linearly, as described above, and to lift or lower the base door 7 accordingly.

FIG. 10 shows the embodiment of the cooking appliance according to FIG. 9 in a sectional front view onto the intersecting plane IV-IV from FIG. 9.

It can be seen that the pitched cables 58 and the guide tubes 56 are deflected from the horizontal to the vertical at the support 57. A (deflection) force which is essentially dependent on the load at the load-bearing section of the pitched cable 58, including the weight of the base door 7 and its loading, is thus exerted on each of the supports 57 by the respective load-bearing section of the pitched cables 58 via the elastically deformable guide tubes 56. In this illustration only the normal components Fn1, Fn2 of the respective deflection force are plotted.

An overloading of the base door 7 or a pinching/jamming situation, for example, can be detected by measuring the deflection force, in particular the respective normal force Fn1 and Fn2 at the corresponding support 57.

An overloading of the base door 7 can be measured for example as a result of a specific load threshold being exceeded.

A pinching/jamming situation in the closing movement direction of the base door 7, i.e. mainly between base door 7 and housing 1, and in the opening direction of the base door 7, i.e. mainly between base door 7 and work surface, can be detected for example if a difference between Fn1 and Fn2 becomes greater than a specific set threshold value. Alternatively, time differences in the relieving of load between the two sides can be detected.

FIG. 11 shows a section indicated by the dashed circle in FIG. 10 in greater detail.

In this case the support 57 moves a switching element 62 which, when the load is relieved, switches a switch 63. In this exemplary embodiment only an undershooting or exceeding of a load threshold can be measured. Possible applications, embodiments and measurement principles are described in this respect in, for example, DE 102 28 140 A1 and DE 101 64 239 A1.

Alternatively, other load-measuring sensors can measure the forces acting on the support 57, in particular, but not only, the normal force Fn. In these cases further evaluation possibilities for detecting a pinching/jamming situation can be used, such as for example a change in speed of the load, which possibly exceeds a specific threshold value or deviates from a reference value (e.g. a displacement speed or speed ramp) and thereby indicates the pinching/jamming situation.

FIG. 12 shows, analogously to the illustration from FIG. 7, a further embodiment of the cooking appliance with an emergency opening arrangement for moving the base door in the event of a power outage affecting the cooking appliance or a failure of the drive motor 9.

The drive motor 9 has, at a leadthrough 64, a toothed wheel in the form of a bevel gear 65 which is in operative connection with the motor shaft (not shown). Also present is a fixed, rotatably mounted shaft 66 which at one end carries a toothed wheel in the form of a bevel gear 67. The other end of the shaft 66 is contrived and arranged as an engagement unit or area 69 for operation by a user. The shaft 66 is fixed to the housing body 34 by means of two retainers 68 and in addition has a restraining element 70 in the form of a spring which during normal operation holds the shaft 66 by means of a restraining force Fr (indicated by the arrow) in a position in which the bevel gear 67 of the shaft is decoupled from the bevel gear 65 of the drive motor 9. The shaft 66 is hexagonal in cross-section, thus allowing for example a control element, e.g. a crank or a hexagonal wrench, to be easily slotted onto the end embodied as the engagement unit 69 (not shown). In normal operation the end embodied as the engagement unit 69 is hidden behind the front panel or front housing cover 35.

In emergency operation, when either the drive motor 9 can no longer be actuated via the operating panel or the power supply to the entire appliance has failed, the base door can still be displaced by means of the emergency opening arrangement. Toward that end, in the present embodiment the front panel is first removed so that the user has access to the engagement unit 69. The user then slots a crank with a suitable cutout onto the shaft 66 and presses the shaft 66 against the restraining spring force Fr with its bevel gear 67 in contact and thus in engagement with the bevel gear 65 of the drive motor 9. The following rotation of the crank causes the drive motor 9 and, connected therewith, the pinion 55 and the pitched cables to move, as a result of which the base door 7 is displaced.

In order to transition to the normal mode of operation, the pressure is taken away from the shaft 66, the crank withdrawn and the front panel replaced.

The toothed wheel or bevel gear 65 can be fixed directly to the motor shaft. The shaft 66 can also be flexible. The actuator can be permanently connected to the engagement unit 69 or, as the case may be, the shaft 66. The emergency opening arrangement can also be characterized such that the shaft does not decouple during normal operation and consequently runs continuously in parallel. Apart from a shaft, any other device which transmits mechanical forces without electrical power, namely from the engagement unit 69 or, as the case may be, an actuator to the motor shaft, is suitable.

### LIST OF REFERENCE SIGNS

1 Housing
2 Wall
3 Cooking chamber
4 Viewing window
5 Muffle
6 Muffle opening
7 Base door
8 Work surface
9 Drive motor
10 Lifting element
11 Control element
12 Operating panel
13 Control circuit
14 Display elements
15 Cooking matrix
16 Cooking hob heating element
17 Cooking hob heating element
18 Panel heating element
19 Glass ceramic plate
20 Securing part
21 Support for items being cooked
22 Top-heat heating element
23 Fan
24 Seal
25 Displacement switch panel
25a Displacement switch, upward
25b Displacement switch, downward
26 Displacement switch panel
26a Displacement switch, upward
26b Displacement switch, downward
27 Memory unit
28 Confirmation button
29 Main switch
30 Motor shaft
31 Hall-effect element
32 Sensing element
33 End switch
34 Housing body
35 Housing cover
36 Intermediate space
37 Lower ventilation openings
38 Upper surface of the housing body (34)
39 Upper ventilation opening
40 Intermediate space
41 First (inner) viewing window
42 Second (middle) viewing window
43 Third (outer) viewing window
44 Intermediate spaces at the sides
45 Front intermediate space
45a First front intermediate space
45b Second front intermediate space
46 Rear intermediate space
47 Electrical or electronic modules
48 Drive device
49 Ventilation device
50 Fan
51 Intake duct
52 Exhaust air duct
53 Air outlet
54 Guide housing
55 Toothed wheel
56 Guide tubes
57 Support
58 Pitched cables
59 Lower telescopic rod
60 Pitched cable fixing element
61 Upper telescopic rod
62 Switching element
63 Switch
64 Housing branch-off
65 Toothed wheel
66 Shaft
67 Toothed wheel
68 Retainers
69 Engagement unit
40 Restraining element
41 Fn1 Normal force 1
Fn2 Normal force 2
Fr Restraining force
P0 Zero position
P1 Intermediate position
P2 Intermediate position
PZ Final position

1-20. (canceled)

21. A cooking appliance comprising:
a cooking chamber;
a muffle which delimits the cooking chamber; the muffle having a muffle opening;
a door for closing the muffle opening;
a drive device; a control device; the drive device controlled by the control device for displacing the door;
a plurality of pitched cables connected to the door; and
the drive device including at least one drive motor for moving the pitched cables linearly.

22. The cooking appliance as claimed in claim 21, further including a support; at least one of the pitched cables is deflected at the support between drive motor and door.

23. The cooking appliance as claimed in claim 22, further including a plurality of supports and a housing boding having an upper surface; the drive motor and the supports are mounted on the upper surface of the housing body.

24. The cooking appliance as claimed in claim 22, further including at least one guide tube; at least one of the pitched cables being at least partially received in a guide tube.

25. The cooking appliance as claimed in claim 24, wherein the at least one pitched cable has a load bearing section, and further including a guide housing; the at least one guide tube extending from the guide housing at least to a support for receiving a load bearing section of at least one of the pitched cables.

26. The cooking appliance as claimed in claim 24 wherein the guide tube is elastically deformable.

27. The cooking appliance as claimed in claim 26, further including a switching device for measuring load; the switching device for measuring load being associated with the support.

28. The cooking appliance as claimed in claim 27, further including a control circuit; the switching device is connected to the control circuit; the control circuit being configured in such a way that it detects a pinching or jamming of the door by evaluating the signals of the switching device.

29. The cooking appliance as claimed in claim 21 wherein the cooking appliance is a high level cooking appliance and wherein the muffle includes a base which forms the muffle opening; the door being a base door.

30. A cooking appliance comprising:
a cooking chamber;
a muffle which delimits the cooking chamber; the muffle having a muffle opening;
a door for closing the muffle opening;
a drive device; a control device; the drive device controlled by the control device for displacing the door;
a plurality of cables connected to the door;
the drive device including at least one drive motor for moving the cables;
at least one of the cables having a load-bearing section between the drive motor and the door; a support; a guide tube; the load bearing section of the cable being deflected at the support and being received in the guide tube at least between the drive motor and the support;
the guide tube being elastically deformable under load; and
a switching device for measuring load; the switching device associated with the support.

31. The cooking appliance as claimed in claim 30, the cables are pitched cables which can be moved in a linear manner by the drive motor.

32. The cooking appliance as claimed in claim 31, further including a guide housing associated with the drive motor; wherein the guide tube receiving the load-bearing section of at least one of the cables extends from the guide housing at least to the support.

33. The cooking appliance as claimed in claim 30, further including a control circuit; the switching device is connected to the control circuit which is configured in such a way that it detects a pinching or jamming of the door by evaluating the signals of the switching device.

34. The cooking appliance as claimed in one of claims 30 wherein the cooking appliance is a high-level built-in cooking appliance and wherein the muffle includes a base which forms the muffle opening; the door being a base door.

35. A method for operating a cooking appliance which includes a cooking chamber, a muffle which delimits the cooking chamber, the muffle having a muffle opening, a door for closing the muffle opening, a drive device, a control device, the drive device controlled by the control device for displacing the door, a plurality of cables connected to the door, the drive device including at least one drive motor for moving the cables, at least one of the cables having a load-bearing section between the drive motor and the door, a support, a guide tube, the load-bearing section of the cable being deflected at the support and being received in the guide tube at least between the drive motor and the support, the guide tube being elastically deformable under load, a switching device for measuring load, the switching device associated with the support, comprising:
elastically deforming the guide tube due to the load applied to at least one of the cables running in the guide tube;
pressing the guide tube onto the support; and
measuring load using a switching device which is triggered by the pressure exerted on the support.

36. The method as claimed in claim 35, further including triggering the switching device for measuring load after a specific load threshold is reached.

37. The method as claimed in claim 36, wherein the switching device for measuring load has a switching element which includes a switch, further including triggering the switch after the measured load falls below a specific load threshold.

38. The method as claimed in claim 35, further including measuring load values in stages by the switching device.

39. The method as claimed in claim 35, further including measuring load values continuously by the switching device.

40. The method as claimed in claim 38 wherein the switching device includes a load measuring outlet.

41. The method as claimed in claim 38 wherein the switching device includes a resistance strain gauge.

42. The method as claimed in claim 39 wherein the switching device includes a load measuring outlet.

43. The method as claimed in claim 39 wherein the switching device includes a resistance strain gauge.
